(19) United States
(12) Patent Application Publication
(10) Pub. No.: US 2018/0213387 A1
(43) Pub. Date: Jul. 26, 2018

(54) COMMUNICATION APPARATUS, COMMUNICATION METHOD, AND PROGRAM

(71) Applicant: CANON KABUSHIKI KAISHA, Tokyo (JP)

(72) Inventor: Hitoshi AOKI, Kawasaki-shi (JP)

(21) Appl. No.: 15/744,484

(22) PCT Filed: Aug. 18, 2016
(86) PCT No.: PCT/JP2016/003776

§ 371 Date: Jan. 12, 2018

(30) Foreign Application Priority Data
Sep. 24, 2015 (JP) 2015-187446

(51) Int. Cl. H04W 8/00

(52) U.S. Cl. CPC H04W 8/005; H04W 4/12

(57) ABSTRACT

A communication apparatus communicates service information with another communication apparatus during a predetermined period which repeatedly starts in a predetermined cycle and during which a plurality of apparatuses including the communication apparatus transmit or receive a beacon, communicates, with the other communication apparatus during the predetermined period, address information to be used for communication for executing a service indicated by the service information, and communicates, using the address information, with the other communication apparatus for executing the service indicated by the service information at a timing based on the predetermined cycle.

### TECHNICAL FIELD

The present invention relates to a communication apparatus, a communication method, and a program.

### BACKGROUND ART

A wireless LAN system represented by IEEE802.11 has been widely used. In the wireless LAN, a base station called an access point (to be referred to as an AP hereinafter) controls a network. A wireless network is formed by the AP and stations (STAs) which fall within the radio wave coverage of the AP and are in a wirelessly connected state. In recent years, products and standards for various wireless LAN network forms have appeared on the market, in addition to this conventional simple wireless network configuration of the AP and STAs.

U.S. Patent Application Publication No. 2014/302787 describes Neighbor Awareness Networking (NAN) which is defined by Wi-Fi Alliance as a communication standard for detecting a communication apparatus and a service provided by it with low power consumption. In NAN, communication apparatuses that configure NAN (hereinafter referred to as NAN devices) synchronize periods in which they exchange information. This can shorten the time during which a wireless RF is enabled, thereby reducing the power consumption. This synchronization period in NAN is called a discovery window (DW). A set of NAN devices which share a predetermined synchronization period is called a NAN cluster.

Each NAN device in the NAN cluster can operate in one of master, non-master sync, and non-master non-sync roles. The terminal having the master role transmits a sync beacon as a signal for causing the respective NAN devices in the same NAN cluster to synchronize with each other during a DW period. The respective NAN devices in the NAN cluster synchronize with each other, and transmit/receive a publish message as a signal for searching for a service and a subscribe message as a signal for sending a notification of provision of a service during the DW period. Furthermore, the respective NAN devices can exchange follow-up messages for exchanging additional information about a service during the DW period. The frame structure of a message such as a publish, subscribe, or follow-up message is defined by the NAN standard, and is called a service discovery frame (SDF). The SDF includes a service ID as an identifier for specifying a target service. The respective terminals can detect a service by exchanging SDFs.

The NAN device can detect a service in the NAN cluster. However, when the NAN device performs communication of an application for actually executing the service after detecting the service, it needs to additionally establish a wireless connection. Communication for executing the service is performed in a network different from the NAN cluster, that is, a network different from NAN, such as an infrastructure network, IBSS, or Wi-Fi Direct. The NAN device establishes a new network, thereby allowing communication by the application. However, in the conventional technique, since apparatuses which have already established synchronization in a NAN cluster additionally establish synchronization for communication in a new network, it is impossible to quickly start communication for executing a service.

### SUMMARY OF INVENTION

In one aspect, a communication apparatus comprises: first communication means for communicating service information with another communication apparatus during a predetermined period which repeatedly starts in a predetermined cycle and during which a plurality of apparatuses including the communication apparatus transmit or receive a beacon; second communication means for communicating, with the other communication apparatus during the predetermined period, address information to be used for communication for executing a service indicated by the service information; and third communication means for communicating, using the address information, with the other communication apparatus for executing the service indicated by the service information at a timing based on the predetermined cycle.

In another aspect, a communication apparatus comprises: first communication means for communicating service information with a communication partner apparatus belonging to a NAN cluster to which the communication apparatus belongs during a discovery window of Neighbor Awareness Networking (NAN); second communication means for communicating an IP address with the communication partner apparatus during the discovery window; and third communication means for communicating with the communication partner apparatus for executing a service indicated by the service information communicated by the first communication means, in accordance with a communication timing synchronized in the NAN cluster using the IP address communicated by the second communication means.

In other aspect, a communication method for a communication apparatus, comprises: communicating service information with another communication apparatus during a predetermined period which repeatedly starts in a predetermined cycle and during which a plurality of apparatuses including the communication apparatus transmit or receive a beacon; communicating, with the other communication apparatus during the predetermined period, address information to be used for communication for executing a service indicated by the service information; and communicating with the other communication apparatus for executing the service indicated by the service information at a timing based on the predetermined cycle using the address information.

In other aspect, a communication method for a communication apparatus, comprises: communicating service information with a communication partner apparatus belonging to a NAN cluster to which the communication apparatus belongs during a discovery window of Neighbor Awareness Networking (NAN); communicating an IP address with the communication partner apparatus during the discovery window; and communicating with the communication partner apparatus for executing a service indicated by the service information communicated in the communicating the service information, in accordance with a communication timing synchronized in the NAN cluster using the IP address communicated in the communicating the IP address.

Further features of the present invention will become apparent from the following description of exemplary embodiments (with reference to the attached drawings).

### BRIEF DESCRIPTION OF DRAWINGS

FIG. 1 is a view showing a wireless network configuration according to an embodiment.

FIG. 2 is a block diagram showing the functional arrangement of a NAN device according to the embodiment.

FIG. 3 is a block diagram showing the hardware arrangement of the NAN device according to the embodiment.

FIG. 4 is a flowchart illustrating data link establishment request processing according to the embodiment.

FIG. 5 is a flowchart illustrating data link establishment standby processing according to the embodiment.

FIG. 6 is a flowchart illustrating data link communication processing according to the embodiment.

FIG. 7 is a sequence chart according to the embodiment.

FIG. 8 is a timing chart schematically showing the relationship between DW periods and DLW periods according to the embodiment.

FIG. 9 is a view showing the structure of an SDF according to the embodiment.

FIG. 10 is a view showing the structure of a data frame according to the embodiment.

### DESCRIPTION OF EMBODIMENTS

The present invention will be described in detail below based on embodiments of the present invention with reference to the accompanying drawings. Note that arrangements to be described in the following embodiments are merely examples, and the present invention is not limited to the illustrated arrangements.

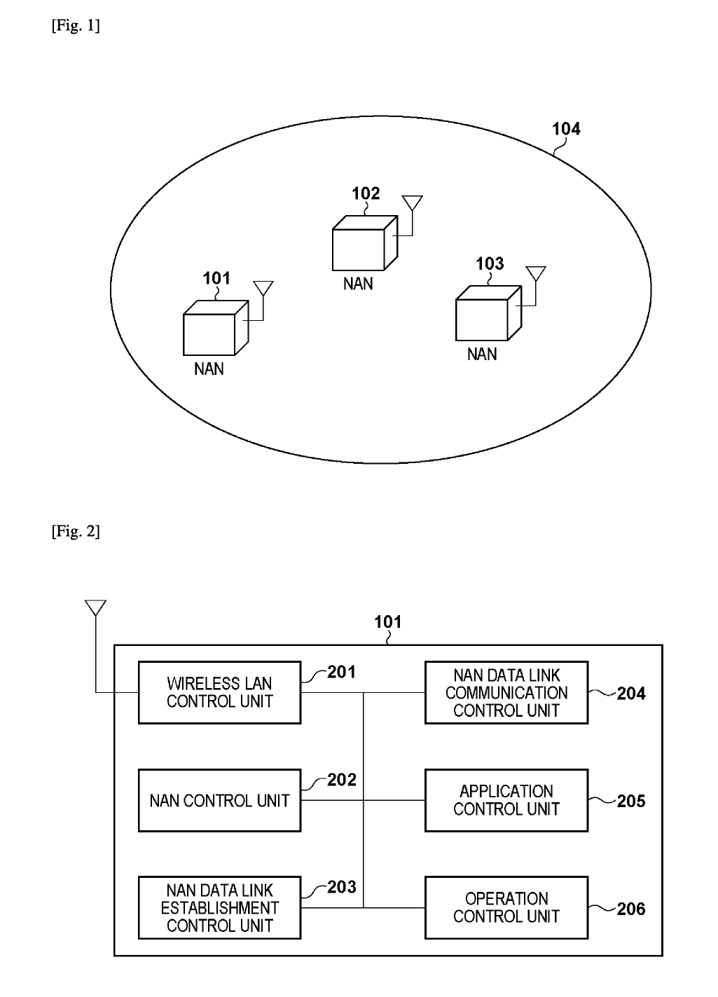

FIG. 1 shows an example of a network configuration according to this embodiment. An example in which a wireless LAN system complying with the Neighbor Awareness Networking (NAN) standard is used will be explained below. In NAN, service information is communicated during a period called a discovery window (to be referred to as a DW hereinafter). The DW indicates the convergence time and channel of a plurality of devices for executing NAN. A set of terminals which share the schedule of DWs is called a NAN cluster. Note that the DW is set in every predetermined cycle.

Each terminal belonging to the NAN cluster operates in one of master, non-master sync, and non-master non-sync roles. The terminal operating in the master role transmits a synchronization beacon (to be referred to as a sync beacon hereinafter) as a beacon for causing each terminal to identify the DW and synchronize with it. In addition, the terminal operating in the master role transmits a discovery beacon as a signal for causing a terminal, which does not belong to the NAN cluster, to recognize the NAN cluster. The discovery beacon is transmitted during a period other than the DW periods for, for example, every 100 ms. Note that at least one terminal in each NAN cluster operates in the master role.

The terminal operating in the non-master sync role transmits not a discovery beacon but a sync beacon. The terminal operating in the non-master non-sync role transmits neither a sync beacon nor a discovery beacon.

In accordance with the sync beacon, the terminal joining the NAN cluster communicates service information during the DW period in synchronous with the DW period set in every predetermined cycle.

The terminals communicate, to each other, a subscribe signal as a signal for detecting or requesting a service and a publish signal as a signal for sending a notification of provision of a service during the DW period. Furthermore, the respective terminals can exchange follow-up signals for exchanging additional information about a service during the DW period. Note that the publish, subscribe, and follow-up signals will be collectively referred to as service discovery frames (SDFs) hereinafter. The respective terminals can advertise or detect the service by exchanging the SDFs.

Each terminal joining the same NAN cluster performs communication using channel 6 (2.437 GHz) in a frequency band of 2.4 GHz. In the NAN cluster, a DW of 16 TUs (Time Units) (1 TU corresponds to 1,024 μsec) is set every 512 TUs. That is, in the NAN cluster, a DW of 16 TUs is repeatedly set every 512 TUs. The respective terminals joining the NAN cluster synchronize the schedules of DWs by sync beacons transmitted/received during the DWs. Each terminal belonging to the NAN cluster communicates service information using the SDFs during each DW period.

In NAN, processing of detecting a service or application and establishing a wireless connection for executing the service or application is called post NAN. In post NAN, a network different from a NAN cluster, that is, a network different from NAN, such as an infrastructure network, IBSS, or Wi-Fi Direct is created. A NAN device can establish a new network and perform communication by an application.

NAN devices 101, 102, and 103 are wireless communication apparatuses for performing wireless communication complying with the NAN standard. Note that the NAN devices 101, 102, and 103 may be any apparatuses which can join NAN and perform communication by an application. Each of the NAN devices 101, 102, and 103 can discover nearby communication apparatuses and services provided by them, and provide the services based on the NAN standard. Referring to FIG. 1, the NAN devices 101, 102, and 103 join a NAN cluster 104. The NAN devices 101 and 103 join the NAN cluster 104 in the non-master sync role, and the NAN device 102 joins the NAN cluster 104 in the master or anchor master role. In this embodiment, the NAN device 101 serves as a subscriber that is searching for a predetermined service. The NAN device 103 serves as a publisher that can provide the predetermined service which the NAN device 101 is searching for.

The NAN cluster 104 is a network which the NAN devices 101, 102, and 103 join. In this embodiment, the NAN devices joining the NAN cluster 104 create a network using channel 6. In the network of the NAN cluster 104, a discovery window (DW) corresponds to 16 TUs, and there is an interval of 512 TUs from the beginning of a DW to that of the next DW. Note that the arrangement of DWs and the wireless channel of NAN are not limited to this.

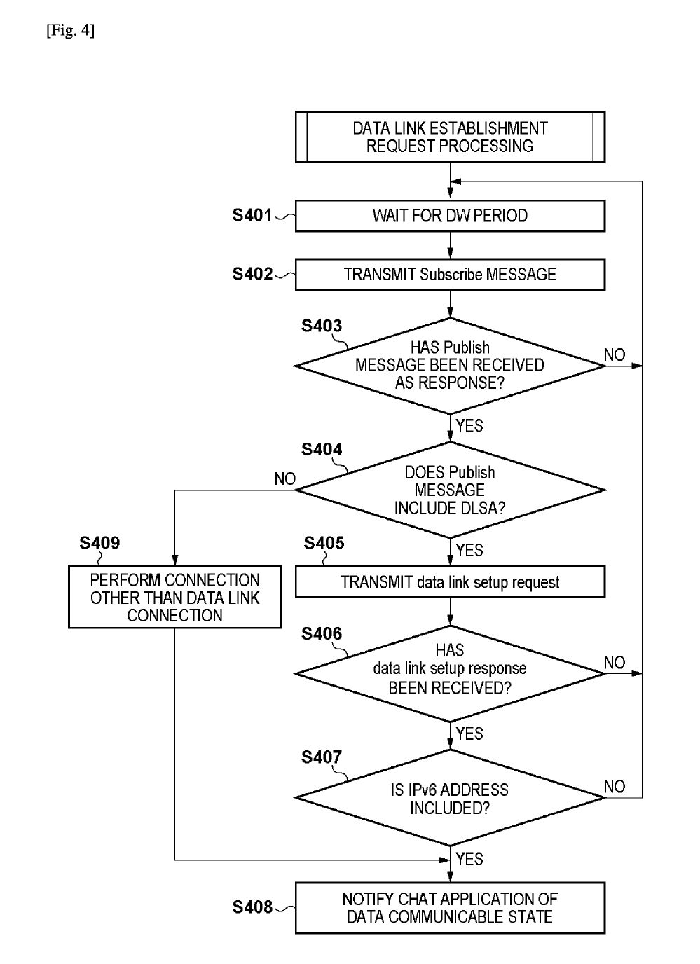

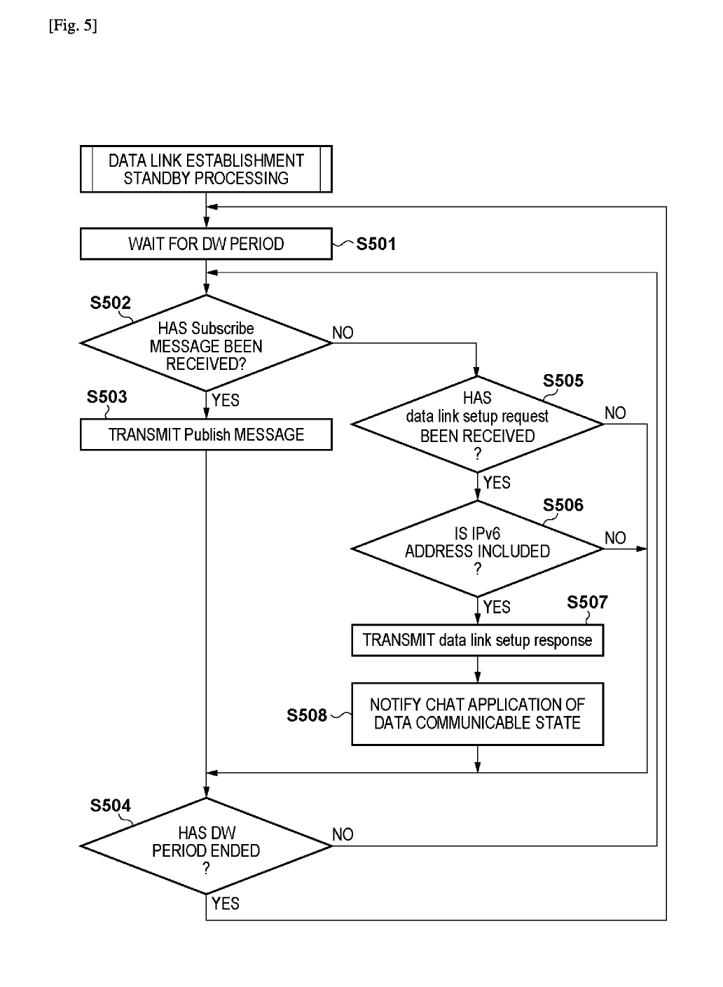

FIG. 2 is a block diagram showing the functional arrangement of the NAN device 101. Note that the functional arrangements of the NAN devices 102 and 103 are the same as that of the NAN device 101. A wireless LAN control unit 201 performs control to transmit/receive a wireless signal to/from another wireless LAN apparatus. The wireless LAN control unit 201 executes wireless LAN control complying with IEEE802.11. A NAN control unit 202 performs control complying with the NAN standard. A NAN data link establishment control unit 203 controls the NAN control unit 202 to perform control to establish a data link layer for performing communication by an application with another NAN device. If the processing of the NAN data link establishment control unit 203 establishes a data link layer, the NAN device 101 can perform data communication by an application. In this embodiment, as an example, after a data link is established, the NAN device 101 can perform IPv6 communication. Detailed processing of establishing a data link will be described later with reference to FIGS. 4 and 5.

A NAN data link communication control unit 204 controls communication by an application using the data link layer established by the NAN data link establishment control unit 203. Under the control of the NAN data link communication control unit 204, the NAN device 101 can transmit/receive IPv6 packets (that is, communicate application data). Detailed processing of communicating application data will be described later with reference to FIG. 4.

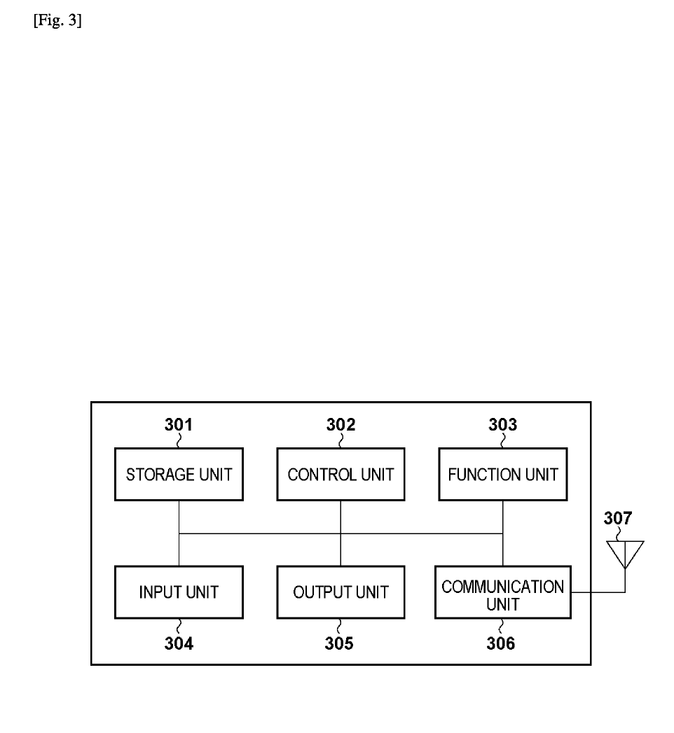

An application control unit 205 performs control to execute a service discovered in NAN. For example, if the NAN device 101 discovers a print service, the application control unit 205 performs control to execute an application of requesting a print job. Alternatively, if the NAN device 101 discovers a photo sharing service, the application control unit 205 performs control to execute an application for exchanging photo data. The NAN device 101 can search for a plurality of services, and include a plurality of application control units 205. In this embodiment, as an example, a chat application is executed as an application between the NAN devices 101 and 103. The user (not shown) of the NAN device 101 searches for a partner for chatting by the chat application. The user (not shown) of the NAN device 103 stands by for a chat partner in the chat application. In this embodiment, assume that the chat application is performed via communication using IPv6. An operation control unit 206 manages an operation performed for the input unit 304 (FIG. 3) by the user of the NAN device 101, and transmits necessary signals to the remaining control units 201 to 205.

FIG. 3 shows the hardware arrangement of the NAN device 101. Note that the hardware arrangements of the NAN devices 102 and 103 are the same as that of the NAN device 101. A storage unit 301 is formed by one or both of a ROM (Read Only Memory) and a RAM (Random Access Memory), and stores programs for performing various operations (to be described later) and various kinds of information such as communication parameters for wireless communication. Note that instead of the memory such as the ROM or RAM, a storage medium such as a flexible disk, hard disk, optical disk, magnetooptical disk, CD-ROM, CD-R, magnetic tape, nonvolatile memory card, or DVD may be used as the storage unit 301.

A control unit 302 is formed by a CPU (Central Processing Unit) or MPU (Micro Processing Unit), and controls the overall NAN device 101 by executing the programs stored in the storage unit 301. Note that the control unit 302 may control the overall NAN device 101 in cooperation with an OS (Operating System) and the programs stored in the storage unit 301. The control unit 302 controls a function unit 303 to execute predetermined processing such as imaging, printing, and projection.

The function unit 303 is hardware used by the NAN device 101 to execute predetermined processing. If, for example, the NAN device 101 is a camera, the function unit 303 serves as an imaging unit, and performs imaging processing. If, for example, the NAN device 101 is a printer, the function unit 303 serves as a printing unit, and performs print processing. If, for example, the NAN device 101 is a projector, the function unit 303 serves as a projection unit, and performs projection processing. Data processed by the function unit 303 may be data stored in the storage unit 301 or data communicated with another NAN device via a communication unit 306 (to be described later).

An input unit 304 accepts various operations from the user. An output unit 305 performs various output operations to the user. The output from the output unit 305 includes at least one of display on a screen, a voice output from a loudspeaker, a vibration output, and the like. Note that both of the input unit 304 and the output unit 305 may be implemented by one module like a touch panel.

The communication unit 306 controls wireless communication complying with the IEEE802.11 series, and controls IP (Internet Protocol) communication. The communication unit 306 controls an antenna 307 to transmit/receive a wireless signal for wireless communication. The NAN device 101 communicates content such as image data, document data, or video data with the other NAN device via the communication unit 306.

Processing executed by the NAN device to request establishment of a data link will be described with reference to FIG. 4. FIG. 4 is a flowchart illustrating data link establishment request processing according to this embodiment. The flowchart shown in FIG. 4 is implemented when the control unit 302 of the NAN device 101 executes a control program stored in the storage unit 301 to execute calculation and processing of information and control of the respective hardware components. Note that some or all of the steps of the flowchart shown in FIG. 4 may be implemented by hardware such as an ASIC. In this embodiment, based on the network configuration described with reference to FIG. 1, the NAN device 101 which requests establishment of a data link discovers a NAN device as a data link establishment destination in the NAN cluster 104. The NAN device 101 transmits a request to establish an actual data link, and receives a response to the request. This establishes a data link This processing starts when the user operates the input unit 304 of the NAN device 101 and a service search corresponding to the chat application starts in the NAN device 101. The processing of the NAN device 101 will be described below but other NAN devices in the NAN cluster 104 can perform the same processing.

The NAN device 101 waits for a cyclic DW period in the NAN cluster 104 (step S401). The NAN device 101 broadcasts a subscribe message during the DW period to search for a NAN device in the NAN cluster 104, in which the chat application is operating or can be executed (step S402). In the subscribe message at this time, a service ID corresponding to the chat application service is designated as a service ID for identifying a service in a service discovery frame (SDF). The subscribe message contains information indicating that a NAN device to which a NAN data link can be established is being searched for.

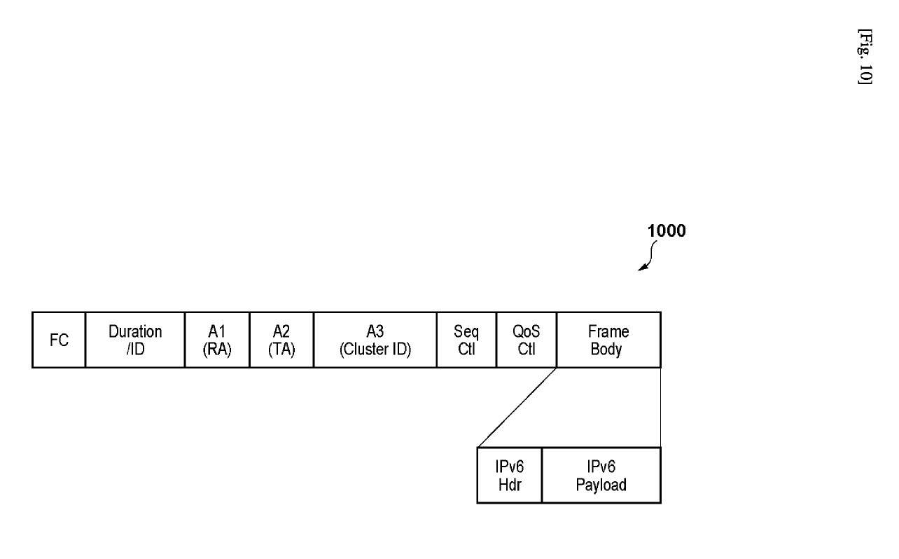

FIG. 9 shows an SDF 900 as the SDF according to this embodiment. The SDF 900 is obtained by extending the SDF complying with the NAN standard. A data link setup attribute (DLSA) 903 is added as one of NAN attributes 901. Since the SDF 900 includes the DLSA 903, the NAN device 101 for transmitting the SDF can request establishment of a NAN data link.

As shown in FIG. 9, in this embodiment, an attribute ID in the DLSA 903 is defined by 0×14. In a type, a numerical value of 0 (data link search) indicating that a NAN device to which a data link can be established is being searched for is designated. Note that a case in which the value of the type is one of 1 to 3 will be described later. In a channel number, the number of wireless channels supported by the NAN device is designated. In a channel list, the wireless channels supported by the NAN device are listed and designated. For example, the NAN device which supports wireless channels 1 to 13 designates 13 in the channel number, and sequentially stores values of 1 to 13 in the channel list. The NAN device which supports wireless channels 36, 40, 44, and 48 designates 4 in the channel number, and designates values of 36, 40, 44, and 48 in the channel list. Note that the NAN device can support both wireless channels in frequency bands of 2.4 GHz and 5 GHz, and may designate both the wireless channels in the channel list.

If “0: data link search” is designated in the type, nothing is designated in an IP address following the channel list. As information following the IP address, an HT capabilities element (IE) and VHT capabilities IE are included. Designation of the HT capabilities IE indicates that 802.11n communication is supported, and designation of the VHT capabilities IE indicates that 802.11ac communication is supported. The HT capabilities IE and VHT capabilities IE can be used to indicate, to the NAN device as a transmission destination, that 802.11n communication and 802.11ac communication are supported. Note that if “0: data link search” is designated in the type, it is not necessary to designate the HT capabilities IE or VHT capabilities IE.

Note that FIG. 9 also shows a data link window attribute (DLWA) 904 but the DLWA 904 need not be included in the subscribe message. A service ID is information included in a service descriptor attribute (SDA) 902. The service ID is the same as that in the NAN standard and a detailed description thereof will be omitted in this embodiment.

Referring back to FIG. 4, the NAN data link establishment control unit 203 determines whether a publish message has been received as a response to the transmitted subscribe message (step S403). At this time, the NAN data link establishment control unit 203 determines whether the service ID included in the received publish message matches that designated in the subscribe message in step S402. If the service IDs match each other, the NAN data link establishment control unit 203 determines that the response to the subscribe message transmitted in step S402 has been received (YES in step S403). If no response can be received (NO in step S403), the NAN data link establishment control unit 203 waits until the next DW period starts (step S401).

Furthermore, the NAN data link establishment control unit 203 confirms whether the publish message includes the DLSA (step S404). FIG. 9 shows the publish message including the DLSA, similarly to the subscribe message. In the case of the publish message, a service control field included in the SDA has a value indicating “publish”. In this embodiment, the DLSA included in the publish message has the following structure. That is, in the type included in the DLSA, a numerical value of 0 (data link search) indicating a NAN device with which NAN data link communication can be performed is designated. No IP address is designated. The HT capabilities IE and the VHT capabilities IE may be included or not.

If the NAN data link establishment control unit 203 has received the publish message including no DLSA (NO in step S404), the terminal as the transmission source of the publish message is a NAN device which does not support establishment of a data link. In this case, the NAN data link establishment control unit 203 performs post NAN connection as connection by another method to perform communication by the chat application (step S409), and the process advances to step S408. The post NAN connection is defined by the NAN standard, and is connection of a data link established by a connection form other than NAN, such as infrastructure, IBSS, Wi-Fi Direct Services, or Mesh after the NAN device is discovered in NAN. Note that the NAN data link establishment control unit 203 need not always perform post NAN connection in step S409. The NAN device 101 which has transmitted the subscribe message may give up communication by the chat application with the NAN device to which no NAN data link can be established.

If the NAN data link establishment control unit 203 can receive the publish message including the DLSA (YES in step S404), it transmits a data link setup request to the NAN device as the transmission source of the publish message to establish a data link (step S405). The data link setup request is a message for requesting NAN data link establishment. FIG. 9 shows the data link setup request, similarly to the subscribe message. In the case of the data link setup request, in the type of the DLSA, a numerical value of 1 (data link setup request) indicating that a setup of a data link is requested is designated. The NAN device 101 which has transmitted the subscribe message serves as a subscriber when executing the chart application. Thus, a value indicating “subscribe” is designated in the service control field of the SDA.

Furthermore, in the channel list, one wireless channel which is used for the data link and is different from that used in the NAN cluster 104 is designated. At this time, one of wireless channels which are included in both the channel list of the subscribe message transmitted in step S402 and the channel list of the publish message received in step S403 is designated. If there is no wireless channel which is included in both the channel lists, the NAN device 101 can give up establishing a NAN data link. In this case, the NAN device 101 designates 1 in the channel number of the data link setup request. In this case, the NAN device 101 may eliminate designation of the channel number and channel list of the data link setup request. If the designation is eliminated, the NAN device 101 uses the same wireless channel as that used in the NAN cluster 104. By eliminating the designation, the data size of the data link setup request can be reduced, thereby reducing the occupation of the band.

Furthermore, the NAN device 101 designates the IP address as address information in the DLSA of the data link setup request. At this time, in this embodiment, an IPv6 link local address is designated in the IP address. Using the IPv6 link local address makes it possible to use an address different from the addresses of other communication apparatuses. In addition, it is not necessary to occupy the time or wireless band for addressing such as DHCP, and it is thus possible to shorten the time until a communicable state is set. It is also possible to prevent the occupation of the wireless band for connection processing by including the IP address in a data link connection request. That is, in general, a two-stage procedure of establishing connection of a data link by association request/response and then addressing the IP address is performed for connection processing. However, a frame exchange count can be decreased by including the IP address in a data link establishment message. Since the plurality of NAN devices in the NAN cluster exchange packets within a short DW period, it is possible to prevent the occupation of the wireless band and provide communication opportunities to other communication apparatuses by establishing a data link and exchanging the IP address by a small number of frames.

If the NAN device 101 can perform 802.11n communication and 802.11ac communication, the pieces of information of the HT capabilities IE and VHT capabilities IE are included in the DLSA.

In this embodiment, the NAN device 101 includes the DLWA 904 in the data link setup request. The NAN device 101 designates, in the DLWA 904, a DW number and a data link bitmap as information indicating a timing, with reference to the DW period, at which communication is performed on the NAN data link.

The DW number is used to represent a DW corresponding to information indicated by the immediately succeeding data link bitmap. For example, if the DW number is 0, whether communication is performed on the data link during a period from a point immediately after DW0 to a point immediately before DW1 is indicated. DWs from DW0 to DW15 are defined by the NAN standard. However, it is not necessary to designate all the DWs. For a DW during which no communication is performed on the data link, it is possible to reduce the data size by designating no DW number.

Each bit of the data link bitmap designates how long a period during which communication is performed on the NAN data link is away from the DW period. More specifically, if the DW period starts at the 0th TU and ends at the 16th TU, the data link bitmap in which the Nth bit is 1 indicates that communication may be performed on the data link during a period from the ((N+1)*16)th TU to the ((N+2)16)th TU. For example, the data link bitmap in which the 0th bit is 1 indicates that communication may be performed on the data link during a period from the 16th TU to the 32nd TU. The data link bitmap in which the 2nd bit is 1 indicates that communication may be performed on the data link during a period from the 48th TU to the 64th TU. In the data link bitmap, 1 may be designated for a plurality of bits. In a period other than the DWs, a period during which communication can be performed on the data link can be designated in a unit of the same time width as that of the DW period. Note that a method of designating a period during which communication is performed on the data link is not limited to the above one as long as a period other than the DW periods is designated.

After transmitting the data link setup request having the above-described structure (step S405), the NAN device 101 waits for reception of a data link response (step S406). FIG. 9 shows the data link setup request, similarly to the subscribe message. In the case of the data link setup request, in the type of the DLSA, a numerical value of 2 (data link setup response) indicating a response to the data link setup request. If the NAN device 101 cannot receive the data link setup response during the current DW (NO in step S406), it waits until the next DW period starts (step S401).

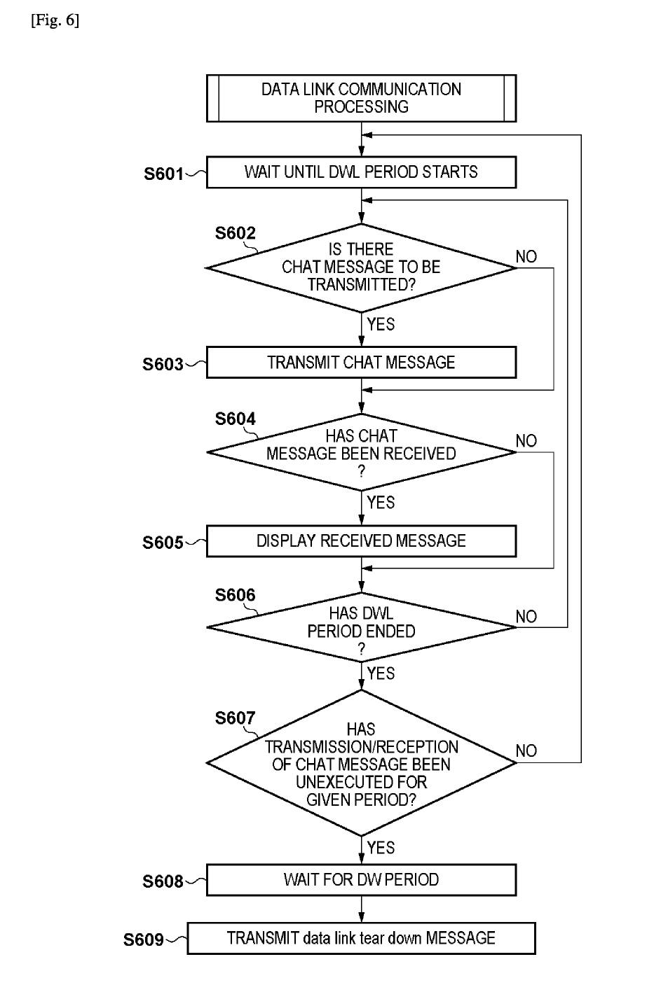

If the NAN device 101 can receive the data link setup response (YES in step S406), it determines whether the IP address of the DLSA included in the received data link setup response includes an IPv6 link local address (step S407). If no IPv6 link local address is included (NO in step S407), the NAN device 101 waits again until the next DW period starts (step S401); otherwise (YES in step S407), the NAN data link establishment control unit 203 of the NAN device 101 notifies the chat application of a data communicable state to indicate a state in which the NAN data link has been established. Even if the processing in step S409 is performed, the NAN data link establishment control unit 203 notifies the chat application of the data communicable state. If the chat application is set in a data communicable state, the NAN device 101 performs NAN data communication. Processing in this case will be described later with reference to FIG. 6.

Processing executed by the NAN device to stand by for a data link establishment request will be described with reference to FIG. 5. FIG. 5 is a flowchart illustrating data link establishment standby processing according to this embodiment. In this embodiment, this processing is performed while the chat application operates in the background of the NAN device 103 based on the network configuration described with reference to FIG. 1. The processing of the NAN device 103 will be described below. However, other NAN devices in the NAN cluster 104 can perform the same processing.

The NAN device 103 waits for a DW period in the NAN cluster 104 (step S501). In terms of the power consumption, the NAN device 103 may turn off wireless transmission/reception during a period other than the DW periods. When a DW period starts, the NAN data link establishment control unit 203 determines whether the NAN device 103 has received a subscribe message including a DLSA (step S502). If the NAN data link establishment control unit 203 confirms that the subscribe message including the DLSA has been received (YES in step S502), it transmits a publish message including, in a DLSA, the service ID of a service supported by the NAN device 103 (step S503). At this time, if one of the service IDs of services supported by the NAN device 103 matches a service ID included in the received subscribe message, the NAN data link establishment control unit 203 may transmit a publish message including the matching service ID. Alternatively, if none of the service IDs of the services supported by the NAN device 103 matches the service ID included in the received subscribe message, the NAN data link establishment control unit 203 may transmit a publish message including no service ID or transmit no publish message.

As described above, if the subscribe message includes the DLSA, the NAN data link establishment control unit 203 includes the DLSA shown in FIG. 9 in the publish message to be transmitted in step S503. Thus, upon receiving the publish message, the NAN device which has transmitted the subscribe message can confirm that the NAN device 103 which has transmitted the publish message supports communication on a NAN data link. Consequently, the NAN device which has transmitted the subscribe message can decide, as needed, whether to establish a NAN data link.

After the NAN device 103 transmits the publish message (step S503), the NAN data link establishment control unit 203 confirms whether the current DW period has ended (step S504). If the current DW period has ended (YES in step S504), the NAN device 103 waits until the next DW period starts (step S501).

If the NAN device 103 has received a message different from the subscribe message in step S502 (NO in step S502), the NAN data link establishment control unit 203 determines whether the received message is a data link setup request (step S505). If the received message is not a data link setup request (NO in step S505), the NAN data link establishment control unit 203 executes the processing in step S504; otherwise (YES in step S505), the process advances to step S506.

In step S506, the NAN data link establishment control unit 203 determines whether it is possible to establish a data link to the NAN device which has transmitted the subscribe message. First, the NAN data link establishment control unit 203 identifies the service ID of the service supported by the NAN device 103 and other application information. Next, the NAN data link establishment control unit 203 confirms whether a channel list included in the DLSA of the received data link setup request includes a wireless channel which can be used by the NAN device 103, and then confirms whether an IP address field includes an IPv6 link local address. Furthermore, the NAN data link establishment control unit 203 confirms whether the received data link setup request includes the DLWA, and a timing which can be specified based on the information included in the DLWA is a timing at which the NAN device 103 can perform transmission/reception.

If the received data link setup request is the above-described data link setup request, the NAN data link establishment control unit 203 transmits a data link setup response to send a notification that a NAN data link is to be established (step S507). The data link setup response at this time has the structure shown in FIG. 9, similarly to the subscribe message. The NAN data link establishment control unit 203 designates, in the channel list of the DLSA, the same wireless channel as that designated in the received data link setup request. Furthermore, the NAN data link establishment control unit 203 designates the IPv6 link local address of the NAN device 103 in the IP address of the DLSA. The NAN data link establishment control unit 203 selects a subset of timings, at which the NAN device 103 can perform transmission/reception, from the DW number and data link bitmap designated in the received data link setup request, and sets it in the DLWA. The set subset is defined as data link windows (to be referred to as DLWs hereinafter) in this embodiment. During the DLW periods as well, communication on the NAN data link is performed.

If the NAN device 103 transmits the data link setup response, a NAN data link is established, and the NAN device 103 notifies the chat application of the data communicable state, similarly to step S407 of FIG. 4 (step S508). At this time, if the chat application operates in the background or the operation of the input unit 304 is in a disable state, the NAN device 103 may notify, via the output unit 305 or the like, the user that a chat is possible.

After the data link to the NAN device 101 is established, the NAN data link communication control unit 204 of the NAN device 103 controls to transmit/receive packets during the DLW periods in addition to the normal NAN DW periods until the establishment of the data link is released. Note that the NAN data link communication control unit 204 exchanges messages for searching for a service and establishing a data link during the DW periods. On the other hand, the NAN data link communication control unit 204 controls to perform data communication by the application during the DLW periods. By separating the periods (DWs) during which a service and a communication apparatus in the NAN cluster are discovered and the periods (DLWs) during which data communication is performed so as not to overlap each other, it is possible to prevent the occupation of each band, thereby further reducing the power consumption.

The communication processing sequence of the chat application using the data link after the data link is established between the NAN devices will be described next. FIG. 6 is a flowchart illustrating data link communication processing according to this embodiment. This processing is executed when the application control unit 205 controls the NAN data link communication control unit 204.

The NAN device waits for a DLW period, described in step S507, during which NAN data link communication can be performed (step S601). When the DLW period starts, the NAN data link communication control unit 204 determines whether there is a chat message input by the user via the input unit 304 (step S602). That is, the NAN data link communication control unit 204 determines whether there is a chat message to be transmitted to the NAN device as a communication partner apparatus to which the NAN data link has been established. If there is a chat message, the NAN device transmits the chat message during the DLW period (step S603). The structure of a frame at this time will be described with reference to FIG. 10. FIG. 10 is a view showing the structure of a data frame 1000 which is transmitted at the time of NAN data link communication according to this embodiment. This data frame is obtained by extending a QoS data frame defined in IEEE802.11. A detailed description of the same points as in IEEE802.11 will be omitted.

In A1 (address 1), the MAC address or interface address of a communication apparatus as the transmission destination of the data frame is designated. In A2 (address 2), the MAC address or interface address of a communication apparatus as the transmission source of the data frame is designated. In A3 (address 3), the cluster ID of a NAN cluster which the communication apparatuses as the transmission destination and transmission source of the data frame join is designated. With this structure, even if a NAN device joins a plurality of NAN clusters, it is possible to recognize a NAN cluster which a NAN device that has transmitted the frame joins.

A frame body includes an IPv6 header (IPv6 Hdr) and an IPv6 payload (IPv6 Payload) as the IPv6 data frame. The IP address transmitted/received during the DW is included as information in the IPv6 header, and the information of communication by the chat application like the chat message is included in the IPv6 payload, and transmitted/received.

If the NAN device transmits the chat message (step S603) or if it is determined that there is no chat message to be transmitted (NO in step S602), chat message reception processing is performed (step S604). If the chat message has been received (YES in step S604), the NAN device notifies the user of the received message and displays it via the output unit 305 or the like (step S605). The structure of the received chat message is the same as that of the data frame shown in FIG. 10.

If the NAN device displays the received message (step S605) or if the NAN device has received no chat message (NO in step S604), it confirms whether the DLW period has ended (step S606). If the DLW period has not ended (NO in step S606), the NAN device starts again processing of determining whether there is a chat message to be transmitted (step S602). If the DLW period has ended (YES in step S606), the NAN data link communication control unit 204 determines whether no chat message has been transmitted/received for a given period (step S607). If a chat message has been transmitted or received during the give period (NO in step S607), the NAN device waits again until a DLW period starts (step S601); otherwise (YES in step S607), the NAN device waits until the next DW period starts (step S608), and transmits a data link tear down message during that DW (step S609). FIG. 9 shows the data link tear down message, similarly to the subscribe message. In the case of the data link tear down message, in the type of the DLSA, a numerical value of 3 (data link tear down) indicating a notification that the establishment of the NAN data link is to be released is designated. Upon transmitting or receiving the data link tear down message, the NAN device releases the NAN data link. After that, the NAN device transmits/receives no wireless frame during the DLW periods.

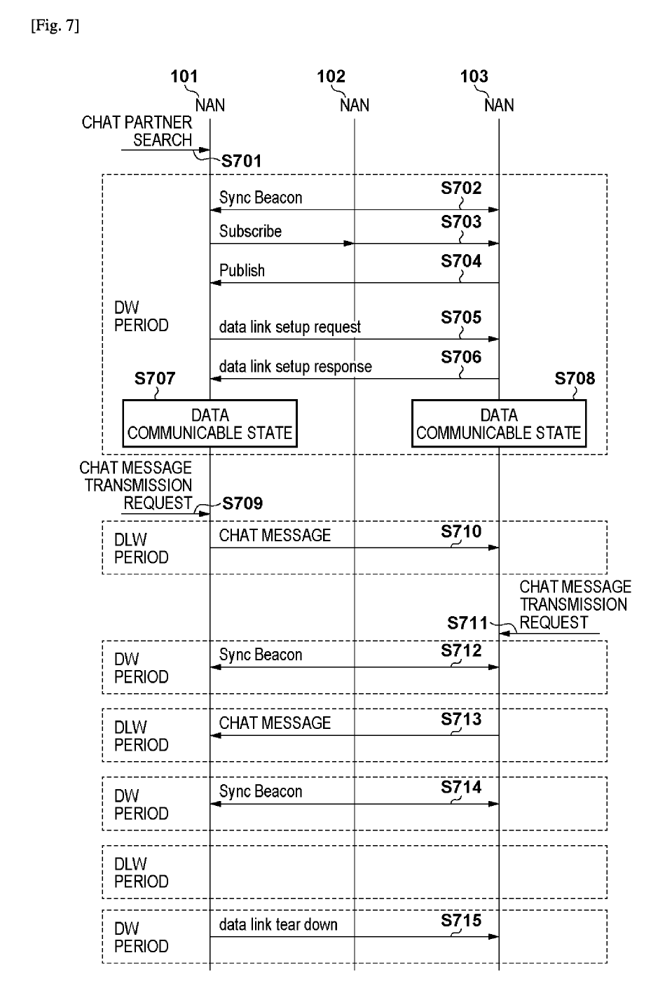

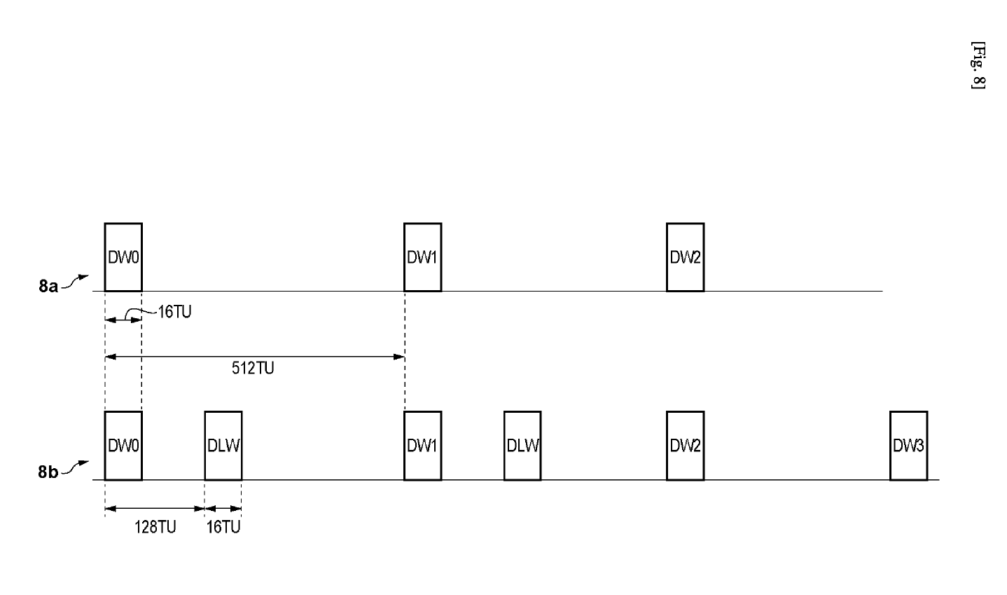

FIG. 7 is a sequence chart showing the sequence of service discovery, establishment of a NAN data link, and application communication processing on the NAN data link according to this embodiment. Assume that the NAN device 101 is searching for a chat partner in the chat application, and the NAN device 103 is performing processing of standing by for a chat partner in the chat application. Assume also that in the NAN device 102, an application other than the chat application is operating.

First, the user of the NAN device 101 causes, via the input unit 304, the chat application to start processing of searching for a chat partner (S701). The NAN device 102 sends a notification of a DW period by a sync beacon (S702). Even if the search processing starts, the NAN device 101 transmits no message before a DW period comes.

If a DW period comes, the NAN device 101 broadcasts a subscribe message to search for the chat application (S703). Upon receiving the subscribe message for searching for the chat application, the NAN device 103 responds to the NAN device 101 using a publish message indicating that the chat application is operating (S704).

If the NAN device 101 receives the publish message, and can determine based on the DLSA that the transmission partner supports communication on a NAN data link, it transmits a data link setup request during the DW period (S705). If the DW period has ended, the NAN device 101 can transmit the data link setup request during the next DW period.

Upon receiving the data link setup request, the NAN device 103 responds to it by a data link setup response (S706). Upon completion of exchange of these messages, a NAN data link is established between the NAN devices 101 and 103, and the NAN devices 101 and 103 are set in a state in which communication by the chat application is possible (S707 and S708). After that, not only during the DW periods but also during DLW periods designated by the data link setup response, packets are wirelessly transmitted/received. That is, the NAN devices 101 and 103 can perform communication on the data link while communication can be continued during the DW periods.

Assume that a chat enable state is set, and the user of the NAN device 101 requests transmission of a chat message (S709). In this case, the NAN device 101 transmits the chat message to the NAN device 103 after the DLW period starts (S710). Upon receiving the chat message, the NAN device 103 notifies its user of the chat message. Assume that the user of the NAN device 103 who has looked at the chat message requests transmission of a chat message (S711). After a DLW period starts, the NAN device 103 transmits the chat message (S713). FIG. 7 shows a case in which during a period from when a chat message transmission request is issued until a chat message is actually transmitted, a DW period starts, and the NAN device 102 transmits a sync beacon (S712 and S714).

If no NAN data link communication is performed for a while after that, the NAN device 101 transmits a data link tear down message to release the NAN data link (S715). After that, the NAN devices 101 and 103 reduce the power consumption by transmitting/receiving no wireless frames during the DLW periods.

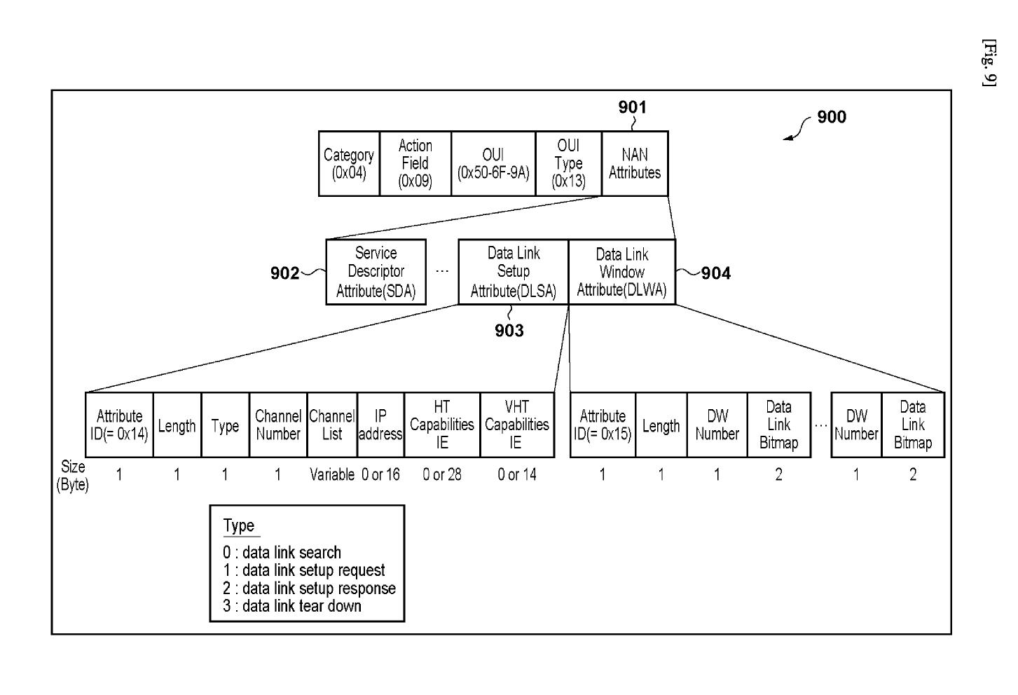

FIG. 8 is a timing chart schematically showing the relationship between the DW periods and the DLW periods. A timing chart 8a shows a case in which no NAN data link is established and packets are transmitted/received during only the DW periods. A timing chart 8b shows a case in which the NAN data link is established and packets are transmitted/received during the DW periods and DLW periods.

Referring to the timing chart 8a, a DW period is set every 512 TUs, and each DW period corresponds to 16 TUs. The timing chart 8a shows a case in which packets are transmitted/received during only the DW periods. During the DW periods, the plurality of NAN devices joining the NAN cluster are active, and thus transmit/receive frames for discovering/detecting a service and establishing a data link. During a period other than the DW periods, no frames are wirelessly transmitted/received, and thus the power consumption can be reduced.

The timing chart 8b shows a case in which the data link is established, DLW periods are respectively set 128 TUs after the start ofDW0 and 128 TUs after the start of DW1, and each DLW period corresponds to 16 TUs. Referring to the timing chart 8b, no DLW period is set 128 TUs after the start of each of DW2 to DW15. That is, in the OLWA of the data link setup response, 0 and 1 are designated in DW numbers, and 0b00000100 is designated in both data link bitmaps corresponding to DW0 and DW1. During the DW periods, the NAN devices operate in the same manner as that described with reference to the timing chart 8a. Furthermore, unlike the timing chart 8a, the NAN devices transmit/receive application data during the DLW periods. During a period other than the DLW periods, no frames are wirelessly transmitted/received, and thus the power consumption can be reduced.

As described above, since a DLW period is set at a communication timing associated with a DW period, and is synchronized with the NAN cluster, it is possible to perform communication on the data link without additionally creating another network. During the DW periods, communication can be performed on the data link while discovering/detecting a service. In addition, the overhead when establishing a data link can be reduced.

According to this embodiment, if a NAN device joins another network as a post NAN network, the NAN cluster and the other network are synchronized with each other at the same timing, and thus control executed for the NAN device to continuously join the NAN cluster is never complicated. That is, according to this embodiment, the NAN device can perform communication for the application while continuously joining the NAN cluster. Therefore, control in the NAN device is never complicated unlike a case in which the NAN device stops the post NAN network and returns to the NAN cluster to perform communication for every DW period. According to this embodiment, it is possible to decrease the probability that the NAN device returns to the NAN cluster during the DW period in communication in the post NAN network to cause a packet loss and the probability that a partner communication apparatus erroneously recognizes that the NAN device has disappeared, and interrupts communication. According to this embodiment, service discovery processing by NAN can be performed when a NAN device wants to search for another service or another communication apparatus even during communication in a post NAN network.

According to this embodiment, it is possible to simplify procedures, as overhead for establishing another network as a post NAN network, such as terminal discovery, exchange of wireless parameters, wireless link establishment, and IP (Internet Protocol) addressing. In the case of an application which performs data communication only sometimes, like the chat application, a decrease in communication efficiency caused by such overhead is reduced.

In this embodiment, since no synchronization signal for synchronization is additionally transmitted for data communication, the occupancy ratio of a band is low. Control may be performed to additionally transmit, at the beginning of a DLW period, a beacon for synchronization or for sending a notification that there is data to be transmitted. In this case as well, since a DLW period is always set a predetermined time after each DW period, it is not necessary to have an additional synchronization timer for another network unlike a case in which a device joins the other network. In either case, since synchronization by a sync beacon during the DW period is maintained, it is possible to maintain service discovery/detection by NAN while performing data communication.

In the above embodiment, the chat application has been described as an application operating in each of the NAN devices 101 and 103. However, the present invention is not limited to this, and is applicable to other applications. For example, a photo sharing application, a print application, or the like may be used.

In the above embodiment, service discovery processing is executed by transmitting a subscribe message. However, a publisher may actively search for a NAN device which requires a service. That is, if a publisher transmits a publish message, and can receive a subscribe message as a response to the publish message, a NAN data link may be established. Furthermore, a NAN data link may be established on either the publisher side or the subscriber side.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-187446, filed Sep. 24, 2015, which is hereby incorporated by reference herein in its entirety.

1. A communication apparatus comprising:
a first communication unit configured to communicate service information with another communication apparatus during a predetermined period which repeatedly starts in a predetermined cycle and during which a plurality of apparatuses including the communication apparatus transmit or receive a beacon;
a second communication unit configured to communicate, with the other communication apparatus during the predetermined period, address information to be used for communication for executing a service indicated by the service information; and
a third communication unit configured to communicate, using the address information, with the other communication apparatus for executing the service indicated by the service information at a timing based on the predetermined cycle.

2. The apparatus according to claim 1, wherein the predetermined period comprises a discovery window (DW) of Neighbor Awareness Networking (NAN).

3. The apparatus according to claim 1, wherein if it can be confirmed via the communication by the first communication unit that a service requested by the communication apparatus is included in a service providable by the other communication apparatus, the third communication unit communicates with the other communication apparatus for executing the service indicated by the service information.

4. The apparatus according to claim 1, wherein if the first communication unit transmits a subscribe message containing information for identifying a predetermined service, and receives, in response to the transmitted signal, from the other communication apparatus, a publish message containing information indicating that communication on a data link is possible and the information for identifying the predetermined service, the third communication unit communicates with the other communication apparatus for executing the service indicated by the service information.

5. The apparatus according to claim 1 4, wherein the address information comprises IP address information.

6. The apparatus according to claim 1, further comprising:
a setting unit configured to set a period for executing the service indicated by the service information is performed,
wherein the third communication unit communicates with the other communication apparatus during the period set by the setting means.

7. The apparatus according to claim 6, wherein the setting unit sets, in a unit of the same time width as that of the predetermined period, the period for executing the service indicated by the service information is performed.

8. The apparatus according to claim 6, wherein
the setting unit further sets a wireless channel for executing the service indicated by the service information, and
the third communication unit communicates with the other communication apparatus using the wireless channel set by the setting unit.

9. The apparatus according to claim 1, wherein if it can be confirmed via the communication by the first communication unit that a service requested by the other communication apparatus can be provided, the third communication unit communicates with the other communication apparatus for executing the service indicated by the service information.

10. The apparatus according to claim 9, wherein if a subscribe message received by the first communication unit contains information for identifying a service providable by the communication apparatus, it is confirmed that the service requested by the other communication apparatus is included in the service providable by the communication apparatus.

11. The apparatus according to claim 10, wherein if a subscribe message received by the first communication unit contains information for identifying a service providable by the communication apparatus, third communication unit communicates with the other communication apparatus for executing the service indicated by the subscribe message.

12. A communication apparatus comprising:
a first communication unit configured to communicate service information with a communication partner apparatus belonging to a NAN cluster to which the communication apparatus belongs during a discovery window of Neighbor Awareness Networking (NAN);
a second communication unit configured to communicate an IP address with the communication partner apparatus during the discovery window; and
a third communication unit configured to communicate with the communication partner apparatus for executing a service indicated by the service information communicated by the first communication unit, in accordance with a communication timing synchronized in the NAN cluster using the IP address communicated by the second communication unit.

13. A communication method for a communication apparatus, comprising:
communicating service information with another communication apparatus during a predetermined period which repeatedly starts in a predetermined cycle and during which a plurality of apparatuses including the communication apparatus transmit or receive a beacon;
communicating, with the other communication apparatus during the predetermined period, address information to be used for communication for executing a service indicated by the service information; and
communicating with the other communication apparatus for executing the service indicated by the service information at a timing based on the predetermined cycle using the address information.

14. (canceled)

15. A non-transitory computer-readable storage medium storing a computer program for causing a computer to execute a communication method for a communication apparatus, the method comprising:
communicating service information with another communication apparatus during a predetermined period which repeatedly starts in a predetermined cycle and during which a plurality of apparatuses including the communication apparatus transmit or receive a beacon;
communicating, with the other communication apparatus during the predetermined period, address information to be used for communication for executing a service indicated by the service information; and
communicating with the other communication apparatus for executing the service indicated by the service information at a timing based on the predetermined cycle using the address information.
